(19) United States
(12) Patent Application Publication
(10) Pub. No.: US 2009/0078104 A1
(43) Pub. Date: Mar. 26, 2009

(54) Guide Plate of Chain Saw

(76) Inventors: Li Shua Chang, Taichung City (TW); Edward Yee-Hua Tsai, Taichung City (TW); Stephen Yee-Fong Tsai, Taichung City (TW)

Correspondence Address: Alan D. Kamrath;Kamrath & Associates, P.A., Suite 245, 4825 Olson Memorial Highway, Golden Valley, MN, 55422, US

(21) Appl. No.: 11/858,968

(22) Filed: Sep. 21, 2007

(51) Int. Cl. B26D 5/00

(52) U.S. Cl. 83/820

(57) ABSTRACT

A guide plate of a chain saw is disclosed and the guide plate comprises: a rectangular metal plate, which is constructed by a body shaped as a guide plate and an eliminated portion elongated around the peripheral of the body; wherein the two surfaces of the front end of the body are elongated to a boundary surface of the eliminated portion individually and corresponding to two indentations of an arc portion toward front, two welded welding powder structures are inside the two indentations so as to let the top surface and the bottom surface of the metal plate be two flat surfaces, the body is separated from the eliminated portion, the welded welding powder structures are disposed at the front edge of the front end of the body, a guide groove is disposed in between the two welded welding powder structures and toward the body.

### BACKGROUND OF THE INVENTION

1. Field of the Invention

The present invention generally relates to a guide plate of a chain saw, more particularly to a guide plate which is capable of saving materials while in manufacturing.

2. Description of the Prior Art

Chain saw is powered to cut wood, stone, etc. and equipped with a power portion and a guide plate firmly disposed on the power portion. A guide groove is disposed on the peripheral of the guide plate so as to let the chain revolve in safety. Therefore, for safety, the design, material, hardness, and convenience of the guide plate are developed from different views.

With reference to FIG. 5, which illustrates a schematic 3-D view of a chain saw in prior arts A chain saw 30 mainly includes a power portion 31, a chain 32 and a guide plate 33; wherein the power portion 31 is wrapped by a case 34 with a handle 35. The guide plate 33 is to guide the chain 32. Due to that the friction of the guiding plate 33 and the chain 32, the hardness and tenacity of the guide plate 33 should comply with requirements in order to prevent the guide plate 13 is damaged by the chain 32.

In general, the front end of the guide plate has two types, one is a sprocket, and the other one is non-sprocket. Wherein the disadvantage of the non-sprocket is that the guide groove is damaged due to that of the steel material of the guide groove being melted while the chain revolves in high speed and temperature Steadite is the best use for the front end of the guide plate. With reference to FIG. 6, which illustrates a schematic sectional view of the chain saw in prior arts and includes a metal plate 41, a guide groove 42 is disposed around the peripheral of the metal plate 41, two steadite plates 43 are connected to the upper and lower edges of the guide groove 42 individually by welding in order to let the guide groove 42 be deeper. Such that, the chain can be embedded in the guide groove 42 for moving back and forth to cut things.

However, the steadite plate 43 is expensive and hardly cut to form the figure what is requested; on the other hand, cutting a little or a lot of material may waste cost, since only laser machining can make it. Another important issue is that decline may be caused by welding the steadite plate 43. Thus the room of the guide groove 42 is not accurate so as to possibly cause the chain jammed.

Therefore the inventor of the present invention has developed an improved guide plate to figure out the disadvantages of prior arts.

### SUMMARY OF THE INVENTION

Problems to be solved in prior arts are described as below. A steadite plate is welded on the front end of the guide plate in prior arts, but the steadite material is expensive and hardly cut to form a figure what is requested except laser machining.

The primary objective of the present invention is to provide a guide plate of a chain saw to solve the problems in prior arts, and the guide plate comprises: a rectangular metal plate, which is constructed by a body shaped as a guide plate and an eliminated portion elongated around the peripheral of the body; wherein the two surfaces of the front end of the body are elongated to a boundary surface of the eliminated portion individually and corresponding to two indentations of an arc portion toward front, two welded welding powder structures are inside the two indentations so as to let the top surface and the bottom surface of the metal plate be two flat surfaces, the body is separated from the eliminated portion, the welded welding powder structures are disposed at the front edge of the front end of the body, a guide groove is disposed in between the two welded welding powder structures and toward the body. Thus, the present invention adopts the in-expensive welded welding powder structures, which are melted on locations where are in higher temperature and wear-resisting and generally machined to form a guide plate.

Compared to prior arts, the present invention adopts the way of welding the welded welding powder structures with steadite material at the front end of the guide plate so as to easily form a figure what is requested, and having no material wasted. It is then that the cost is down. On the other hand, the newly formed guide plate is more accurate and safer, so that the jammed chain will not be happening.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic 3-D view of the present invention;

FIG. 2 illustrates a schematic structural view of forming two indentations of the present invention;

FIG. 2A illustrates a schematic sectional view of the two indentations and two welded welding powder structures of the present invention;

FIG. 3 illustrates a schematic structural view of separating an eliminated portion of the present invention;

FIG. 4 illustrates a schematic structural view of forming a guide groove of the present invention; and

FIG. 5 illustrates a schematic 3-D view of a chain saw in prior arts; and

FIG. 6 illustrates a schematic sectional view of the chain saw in prior arts.

### DETAILED DESCRIPTION OF THE INVENTION

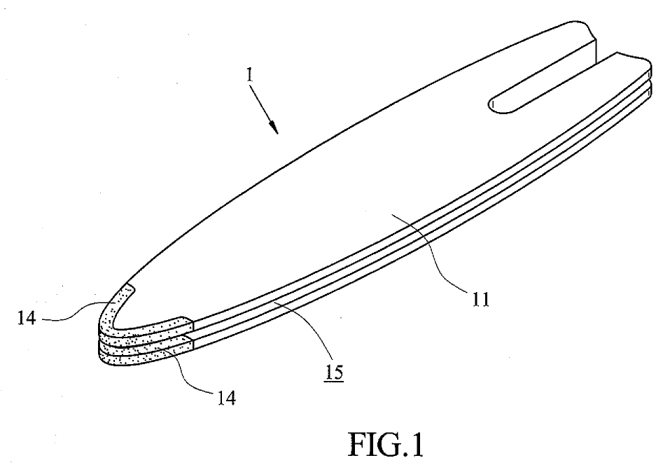

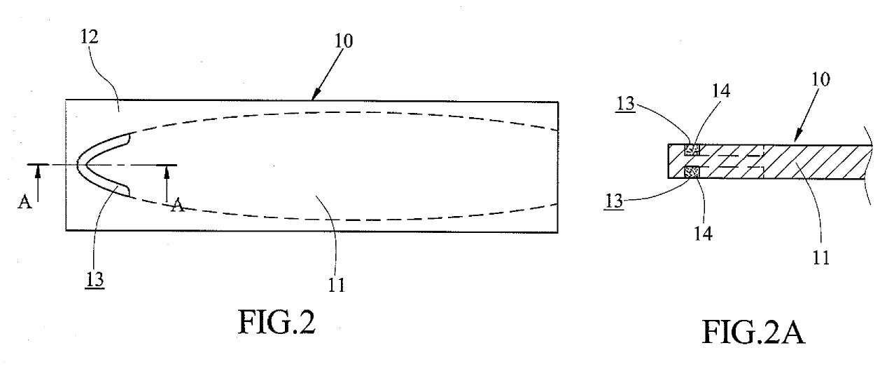

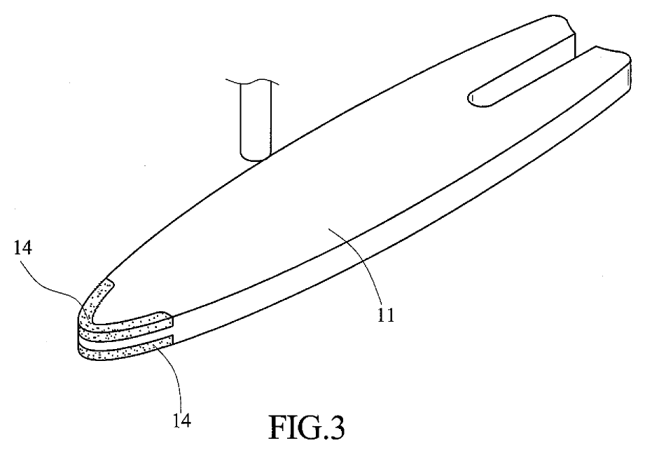

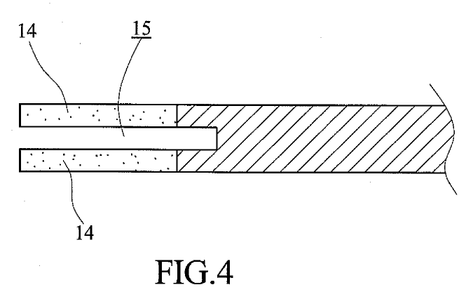

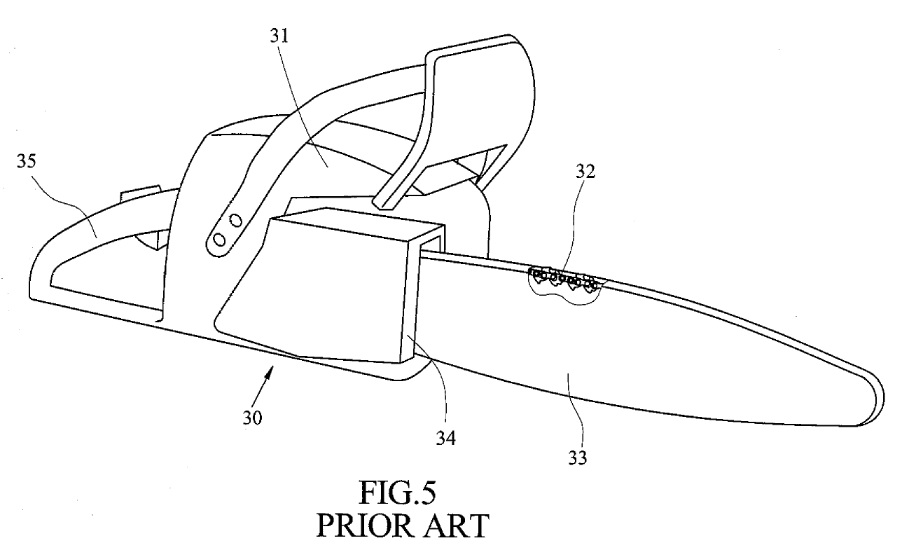

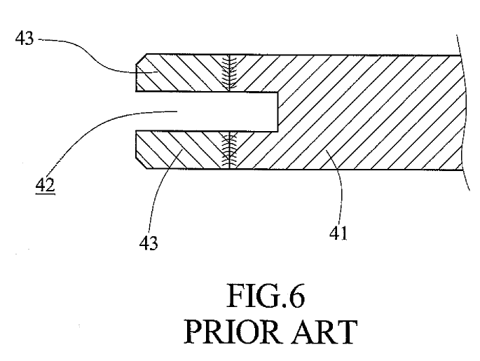

With reference to FIG. 1 to FIG. 4, which are illustrating a schematic 3-D view of the present invention; a schematic structural view of forming two indentations of the present invention; a schematic sectional view of the two indentations and two welded welding powder structures of the present invention; a schematic structural view of separating an eliminated portion of the present invention; and a schematic structural view of forming a guide groove of the present invention; the guide plate 1 of the chain saw of the present invention includes: a rectangular metal plate 10 in FIG. 2, which is constructed by a body 11 shaped as a guide plate and an eliminated portion 12 elongated around the peripheral of the body 11, as shown in FIG. 2; wherein the two surfaces of the front end of the body 11 are elongated to a boundary surface of the eliminated portion 12 individually and corresponding to two indentations 13 of an arc portion toward front, as shown in FIG. 2A, the two indentations 13 are shaped as two semi-ellipses, two welded welding powder structures 14 are inside the two indentations 13 so as to let the top surface and the bottom surface of the metal plate 10 be two flat surfaces, the body 11 is separated from the eliminated portion 12, the welded welding powder structures 14 are disposed at the front edge of the front end of the body 11, as shown in FIG. 3, a guide groove 15 is disposed in between the two welded welding powder structures 14 and toward the body 11, as shown in FIG. 1 and FIG. 4.

Herewith, the rear end of the guide plate 1 can be disposed on a power portion and the guide groove 15 accommodates the chain so as to let the teeth of the chain moves along the guide groove 15 for cutting things.

By means of the two surfaces of the front end of the body 11 elongated to the boundary of eliminated portion 12 milling the two indentations 13 and filling out steadite welding powder, then making such steadite welding powder to become the two welded welding powder structures 14 by curing process, and continuously separating the eliminated portion 12 from the metal plate 10 by milling process in order to left the body 11 with a figure as the guide plate, finally the guide groove 15 is formed by way of inwardly milling a location between the two welded welding powder structures 14 on the front end of the peripheral of the body 11 so as to let the guide groove 15 embed with the chain of the chain saw.

The welded welding powder structure 14 is made by melting the lower coast steadite powder to where is in higher temperature and wear-resisting and generally machined to form a guide plate. This is to be convenient to form the shape what is needed for saving cost.

Besides, the welded welding powder structure 14 is combined with the body 11 accurately to make the room of the guide groove 15 be more precise. So that the safety is higher while the chain is in high speed, and the chain being jammed will be happening.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A guide plate of a chain saw comprising:
a rectangular metal plate, which is constructed by a body shaped as a guide plate and an eliminated portion elongated around the peripheral of the body;
wherein the two surfaces of the front end of the body are elongated to a boundary surface of the eliminated portion individually and corresponding to two indentations of an arc portion toward front, two welded welding powder structures are inside the two indentations so as to let the top surface and the bottom surface of the metal plate be two flat surfaces, the body is separated from the eliminated portion, the welded welding powder structures are disposed at the front edge of the front end of the body, a guide groove is disposed in between the two welded welding powder structures and toward the body.

2. The guide plate of the chain saw according to claim 1, wherein the two indentations are shaped as two semi-ellipses.
